(19) United States
(12) Patent Application Publication
(10) Pub. No.: US 2003/0229418 A1
(43) Pub. Date: Dec. 11, 2003

(54) Stake vending system

(76) Inventor: Shih-Hao Huang, Taichung City (TW)

Correspondence Address: LADAS & PARRY, Suite #2100, 5670 Wilshire Boulevard, Los Angeles, CA, 90036-5679, US

(21) Appl. No.: 10/303,100

(22) Filed: Nov. 21, 2002

(30) Foreign Application Priority Data
Jun. 7, 2002 (TW) 091112418

(51) Int. Cl. G06F 17/00

(52) U.S. Cl. 700/237

(57) ABSTRACT

A stake vending system includes a customer service terminal, a customer terminal, and a stake purchase certificate. The customer service terminal includes a security unit to verify a customer's identity, a banking unit for banking services, and a stake vending unit to keep track of purchased stakes. The customer terminal includes a user input unit for selecting banking transactions or betting groups, a display unit for displaying banking and stake purchase transactions, a purchase authentication unit to communicate with and gain authentication from the customer service terminal, and a printing unit for printing banking transaction and/or stake purchase receipts. The stake purchase certificate is used by the customer to log into the customer terminal to enable the security unit to verify the identity of the customer.

### CROSS-REFERENCE TO RELATED APPLICATION

This application claims priority of Taiwanese application no. 091112418, filed on Jun. 7, 2002.

### BACKGROUND OF THE INVENTION

1. Field of the Invention

The invention relates to a stake vending system, more particularly to a fully automated stake vending system to reduce labor costs and to result in faster transactions.

2. Description of the Related Art

There are three operations involved when completing a stake purchase transaction in a conventional stake vending system:

1) A customer tells a vendor in a stake vending outlet his selected betting group.

2) The vendor inputs and uploads the selected betting group to a customer service terminal of a stake provider via a terminal connected on-line thereto.

3) After completion of the aforesaid uploading operation, a transaction receipt is printed and handed to the customer.

The following are some of the drawbacks of the aforesaid conventional stake vending system:

1) Ideally, stake vending outlets must hire a large number of vendors for fast stake purchase processing. However, in consideration of operating costs, the number of vendors actually hired in a stake vending outlet is very limited. Therefore, customers must wait in long queues and take up a lot of time to complete stake purchase transactions. In other words, the labor costs in handling stake purchases are high while the processing efficiency is low. The conventional stake vending system is thus not cost-effective.

2) In the event that a customer wishes to place a large amount of stakes, not only is it inconvenient and troublesome for the customer to carry large amounts of cash, customer security concerns also arise.

3) Furthermore, a large daily cash flow for each stake vending outlet involves a lot of security and management issues that stake providers must but cannot easily resolve.

### SUMMARY OF THE INVENTION

Therefore, the main object of the present invention is to provide a stake vending system that can overcome the aforesaid drawbacks of the prior art.

Accordingly, the stake vending system of the present invention comprises a customer service terminal, a customer terminal, and a stake purchase certificate.

The customer service terminal includes a security unit adapted to verify identity of a customer and to authorize stake purchasing by the customer, a banking unit associated with the security unit and adapted to perform banking transactions, and a stake vending unit associated with the security unit and the banking unit and adapted to keep track of stakes purchased by the customer.

The customer terminal includes a user input unit, a display unit, a purchase authentication unit, and a printing unit. The user input unit is manually operable so as to select service items provided by the customer service terminal, the service items including betting group selection and transaction amount selection. The display unit is adapted to show interaction and transaction between the user input unit and the customer service terminal, including selected betting group, transaction amount and remaining customer credit. The purchase authentication unit is associated with the user input unit and the display unit and is connected to the customer service terminal on-line. The purchase authentication unit is configured to process transactions related to stake purchasing by the customer, including transmission of selected betting group and transaction amount to the customer service terminal, and receipt of transaction information from the banking unit and confirmation of purchased stakes from the stake vending unit. The printing unit is associated with the purchase authentication unit and is adapted to generate at least one of a stake purchase receipt and a banking transaction receipt.

The stake purchase certificate is associated with the customer terminal and is used by the customer to log into the customer terminal to enable the security unit to verify the identity of the customer.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram showing a preferred embodiment of a stake vending system according to the present invention;

FIG. 2 is a block diagram showing a customer service terminal and a purchase authentication unit of the preferred embodiment;

FIG. 3 is a schematic front view of a customer terminal of the preferred embodiment; and

FIG. 4 is a flowchart illustrating a stake purchase transaction of the preferred embodiment.

### DETAILED DESCRIPTION OF THE PREFERRED EMBODIMENT

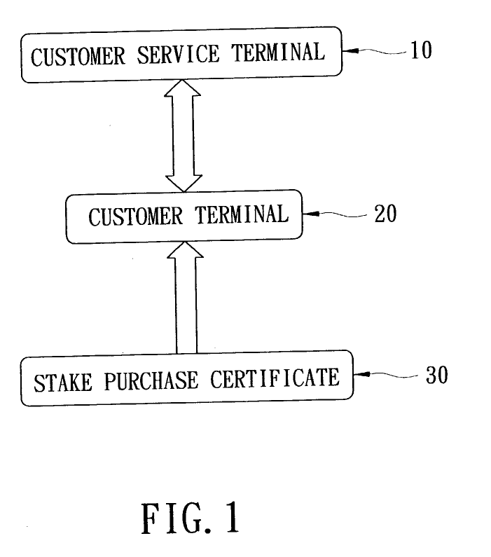

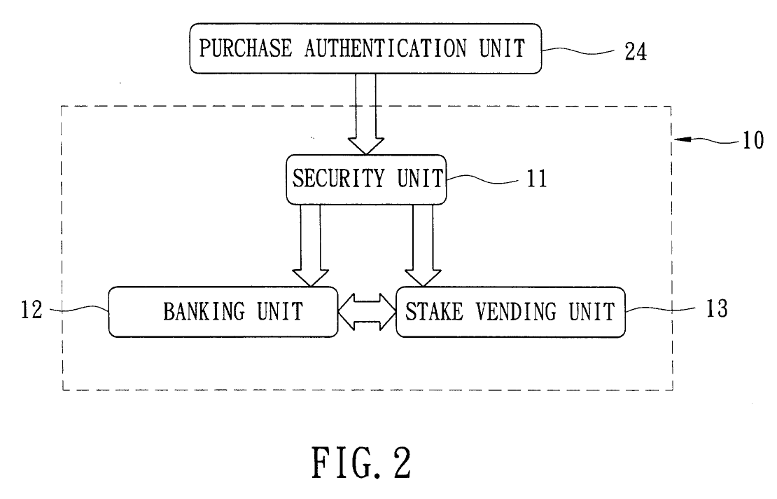

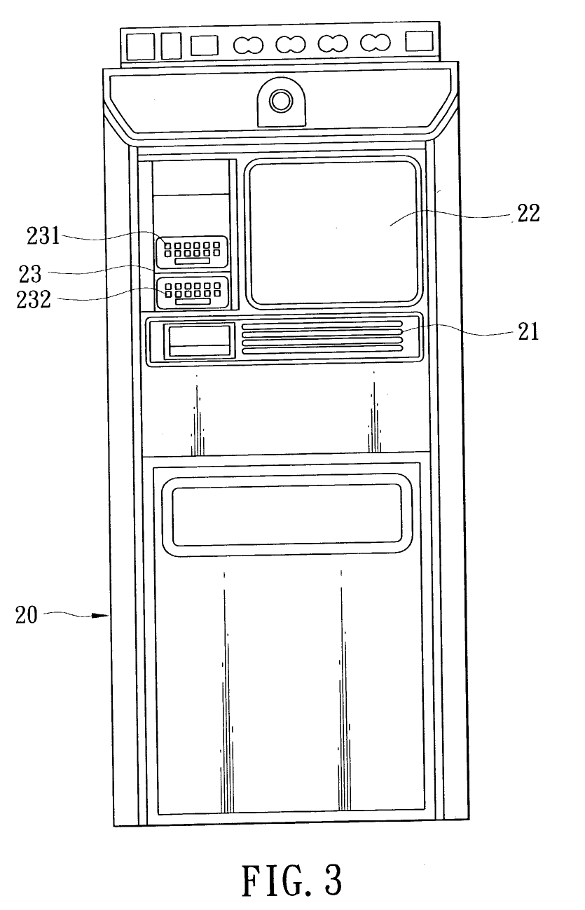

Referring to FIGS. 1, 2 and 3, the preferred embodiment a stake vending system according to the present invention is shown to include a customer service terminal 10, a customer terminal 20 and a stake purchase certificate 30.

The customer service terminal 10 includes a security unit 11, a banking unit 12 and a stake vending unit 13. The security unit 11 is adapted to verify the identity of a customer and to authorize stake purchasing by the customer. The banking unit 12 is associated with the security unit 11 and is connected to banking institutions. The banking unit 12 keeps track of the customer's remaining credits, and is adapted to perform known banking transactions, such as withdrawals, deposits, transfers and inquiries. The stake vending unit 13 is associated with the security unit 11 and the banking unit 12 and is adapted to keep track of stakes purchased by the customer.

In this embodiment, the customer terminal 20 is a stand-alone card-reader, such as an automated teller machine (ATM) of a banking institution. The customer terminal 20 includes a user input unit 21, a display unit 22, a purchase authentication unit 24, and a printing unit 23. The user input unit 21, such as a keyboard, is manually operable so as to select service items provided by the customer service terminal 10, the service items including betting group selection and transaction amount selection. The display unit 22 is adapted to show interaction and transaction between the user input unit 21 and the customer service terminal 10, including selected betting group, transaction amount and remaining customer credit. The purchase authentication unit 24 is associated with the user input unit 21 and the display unit 22 and is connected to the customer service terminal 10 on-line. The purchase authentication unit 24 is configured to process transactions related to stake purchasing by the customer, including transmission of selected betting group and transaction amount to the customer service terminal 10, and receipt of transaction information from the banking unit 12 and confirmation of purchased stakes from the stake vending unit 13. The printing unit 23 is associated with the purchase authentication unit 24 and is adapted to generate at least one of a stake purchase receipt and a banking transaction receipt.

In this embodiment, the stake purchase certificate 30 is one of a credit card, a bank card and a prepaid card provided by a stake provider. The stake purchase certificate 30 is associated with the customer terminal 10 and is used by the customer to log into the customer terminal 10 to enable the security unit 11 to verify the identity of the customer. In case that the stake purchase certificate 30 is a credit card or a bank card, the transaction amount can be deducted directly from the customer's account through the connection to and communication between related banking institutions. In the case that the stake purchase certificate 30 is a prepaid card provided by a stake provider, the transaction amount is deducted directly from remaining balance of the prepaid card.

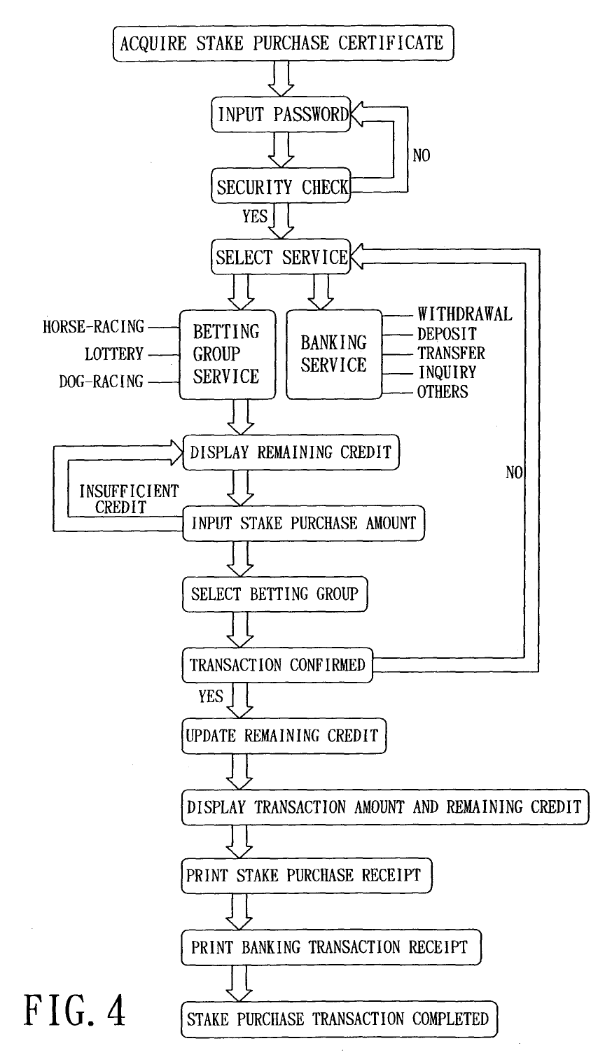

With further reference to FIG. 4, for a customer to initiate a stake purchase, the stake purchase certificate 30 is first inserted into the customer terminal 20. Then, a password is inputted by the customer to complete the log-in process to the customer terminal 20 to enable the security unit 11 of the customer service terminal 10 to verify the identity of the customer. Once the customer's identity has been verified, the customer service terminal 10 will authorize the customer for further service. Thereafter, via the user input unit 21 and the display unit 22, the customer can select service items, such as withdrawal, deposit, bank transfer, account inquiry and other banking transactions, or select available betting groups, such as lottery, dog race betting or horse race betting. When the customer selects a betting group, the purchase authentication unit 24 will first confirm with the banking unit 12 the customer's remaining credit, and enables the display unit 22 to show the remaining credit thereon. When the customer inputs a stake purchase amount, and the customer's remaining credit is sufficient to cover the stake purchase amount, the customer will be allowed to select a betting group, and the transaction will be confirmed. At this time, the customer terminal 20 will transmit the stake purchase amount to the banking unit 12 for deduction from the customer's account, and transmit the selected betting group to the stake vending unit 13 to keep track of the stakes purchased by the customer.

Thereafter, the banking unit 12 will transmit the customer's updated remaining credit to the customer terminal 20, and the stake vending unit 13 will send a transaction confirmed message to the customer terminal 20. The display unit 22 will then display the transaction amount, the remaining credit, and the confirmed selected betting group accordingly. Finally, depending on service items selected or available betting groups selected, the printing unit 23 will either print and provide a stake purchase receipt via a first printout exit 231, or print and provide a banking transaction receipt via a second printout exit 232. The stake purchase receipt contains a login barcode, a prize certifying computer code, etc., to be used when claiming stake winnings. The banking transaction receipt contains the selected service item, the transaction amount, the remaining credit, etc.

It is worth noting that the customer terminal in this invention can be implemented as a household computer capable of on-line connection with the customer service terminal 10. The customer can use the computer for inputting passwords or electronic authentication for authorization during stake purchasing, and select account transfer or payment using bank or credit cards. Via the keyboard and monitor of the computer, the customer can select service items or available betting groups. The computer will then transmit the stake transaction amount to the banking unit 12 for deduction from the customer's account, and transmit the selected betting group to the stake vending unit 13 to keep track of purchased stakes. The banking unit 12 will transmit the updated remaining credit and the stake vending unit 13 will send a transaction confirmed message for subsequent display by the computer. Finally, a printer connected to the computer can be used to print the stake purchase receipt and/or the banking transaction receipt.

The following are some of the advantages of the stake vending system of this invention:

1) To the stake vending outlets, while there is a need to spend for the cost of the customer terminals 20, the maintenance cost thereof is very small as compared to the salaries of hired vendors. Moreover, the extension of service to home computer user not only saves operating costs but also widens the customer base.

2) The cost-effective factor will make the installation of customer terminals 20 more accessible than conventional stake vending outlets, and also resolve the problem of long queues.

3) The on-line connection with banking systems and institutions not only assures customers' and providers' security and promotes operating convenience, but also yields more effective transaction management.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A stake vending system comprising:
a customer service terminal including
a security unit adapted to verify identity of a customer and to authorize stake purchasing by the customer,
a banking unit associated with said security unit and adapted to perform banking transactions, and
a stake vending unit associated with said security unit and said banking unit and adapted to keep track of stakes purchased by the customer;
a customer terminal including
a user input unit manually operable so as to select service items provided by said customer service terminal, said service items including betting group selection and transaction amount selection,
a display unit adapted to show interaction and transaction between said user input unit and said customer service terminal, including selected betting group, transaction amount and remaining customer credit,
a purchase authentication unit associated with said user input unit and said display unit and connected to said customer service terminal on-line, said purchase authentication unit being configured to process transactions related to stake purchasing by the customer, including transmission of selected betting group and transaction amount to said customer service terminal, and receipt of transaction information from said banking unit and confirmation of purchased stakes from said stake vending unit, and
a printing unit associated with said purchase authentication unit and adapted to generate at least one of a stake purchase receipt and a banking transaction receipt; and
a stake purchase certificate associated with said customer terminal and used by the customer to log into said customer terminal to enable said security unit to verify the identity of the customer.

2. The stake vending system as claimed in claim 1, wherein said stake purchase certificate is one of a credit card, a bank card and a prepaid card.

3. The stake vending system as claimed in claim 1, wherein said customer terminal is a stand-alone card-reader.

4. The stake vending system as claimed in claim 1, wherein said customer terminal is a computer capable of on-line connection with said customer service terminal.

5. The stake vending system as claimed in claim 1, wherein the betting groups available for selection include at least one of lottery and race betting.

6. A stake vending system adapted for use with a stake purchase certificate of a customer, said stake vending system comprising:
a customer service terminal including
a security unit adapted to verify identity of the customer and to authorize stake purchasing by the customer,
a banking unit associated with said security unit and adapted to perform banking transactions, and
a stake vending unit associated with said security unit and said banking unit and adapted to keep track of stakes purchased by the customer; and
a customer terminal including
a user input unit manually operable so as to select service items provided by said customer service terminal, said service items including betting group selection and transaction amount selection,
a display unit adapted to show interaction and transaction between said user input unit and said customer service terminal, including selected betting group, transaction amount and remaining customer credit,
a purchase authentication unit associated with said user input unit and said display unit and connected to said customer service terminal on-line, said purchase authentication unit being configured to process transactions related to stake purchasing by the customer, including transmission of selected betting group and transaction amount to said customer service terminal, and receipt of transaction information from said banking unit and confirmation of purchased stakes from said stake vending unit, and
a printing unit associated with said purchase authentication unit and adapted to generate at least one of a stake purchase receipt and a banking transaction receipt;
wherein said customer terminal is associated with the stake purchase certificate and is adapted to permit customer log-in using the stake purchase certificate so as to enable said security unit to verify the identity of the customer.
